(19) United States
(12) Patent Application Publication
(10) Pub. No.: US 2014/0190558 A1
(43) Pub. Date: Jul. 10, 2014

(54) TANDEM SOLAR CELL

(71) Applicants: Nobuaki Komatsu, Tokyo (JP); Tomoko Ito, Tokyo (JP); Tadao Ochiai, Tokyo (JP); Shin-ichiro Nanjo, Tokyo (JP)

(72) Inventors: Nobuaki Komatsu, Tokyo (JP); Tomoko Ito, Tokyo (JP); Tadao Ochiai, Tokyo (JP); Shin-ichiro Nanjo, Tokyo (JP)

(73) Assignee: INTERNATIONAL FRONTIER TECHNOLOGY LABORATORY, INC., Tokyo (JP)

(21) Appl. No.: 14/126,304

(22) PCT Filed: Jun. 14, 2012
(86) PCT No.: PCT/JP2012/065213

§ 371 Date: Mar. 18, 2014

(30) Foreign Application Priority Data
Jun. 14, 2011 (JP) 2011-131834
Jul. 12, 2011 (JP) 2011-154243

(51) Int. Cl. H01G 9/20

(52) U.S. Cl. CPC H01G 9/2072
USPC 136/255

(57) ABSTRACT

A solar cell is configured by: arranging two glass substrates, each of which is provided with a transparent conductive layer, so that the transparent conductive layers face each other; disposing a titanium dioxide layer on one glass substrate; disposing silicon dioxide particles on the other glass substrate; and filling the space between the two glass substrates with an electrolyte. The glass substrate on which light does not enter may alternatively be a metal plate. A sensitizing dye such as a ruthenium complex may be absorbed onto the titanium dioxide layer or the silicon dioxide layer. Since the titanium dioxide layer generates electric power by means of ultraviolet light incident thereon and the silicon dioxide layer generates electric power by means of visible light and infrared light incident thereon, the generation efficiency of the solar cell is increased.

### TECHNICAL FIELD

The present invention relates to a tandem solar cell containing a titanium dioxide solar cell and a silicon dioxide solar cell combined.

### BACKGROUND ART

A solar cell using a semiconductor, such as silicon, is being put to practical use. A semiconductor solar cell has a high generation efficiency but is expensive due to the use of high purity materials.

Examples of a relatively inexpensive solar cell include a solar cell using titanium dioxide (TiO₂).

FIG. 1 shows the basic structure of the titanium dioxide solar cell.

In FIG. 1, numerals 1 and 3 denote glass substrates each forming on one surface thereof an FTO transparent conductive layer 2, and light enters on the side of the glass substrate 1. Numeral 6 denotes a porous titanium dioxide sintered material. Numeral 5 denotes an electrolytic solution, for which an iodine electrolyte containing iodine dissolved in a potassium iodide aqueous solution is generally used.

Numeral 4 denotes a sealing material, and 7 denotes a load, such as a resistor.

In the figure, the hatched arrow shows ultraviolet light, the white arrow shows visible light, and the black arrow shows infrared light. Transmitted light that is largely attenuated is expressed by a shortened arrow, and transmitted light that is not attenuated or with a small attenuation is expressed by the original arrow. The above expressions are applied to the figures hereinafter.

Light that allows titanium dioxide the electric generation is only ultraviolet light having the wavelength of 380 nm or less, and the ultraviolet light within the wavelength range constitutes only 4% of the sunlight. Accordingly, the use efficiency of the sunlight, which is the most abundant light resources, is 4% at maximum and is practically 1% at most, and the use efficiency of the sunlight is very low.

For addressing the defect of the titanium dioxide solar cell having a narrow usable wavelength range, a dye sensitized solar cell (DSSC) having a usable light range that is expanded to the visible light region having the longer wavelength than ultraviolet light by adsorbing a ruthenium complex dye to sintered porous titanium dioxide is known as a Gretzel cell.

The basic structure of the dye sensitized solar cell is described with reference to FIG. 2.

In FIG. 2, numerals 1 and 3 denote glass substrates each forming on one surface thereof an FTO transparent conductive layer 2 and 2, and light enters on the side of the glass substrate 1. Numeral 8 denotes a porous titanium dioxide sintered material having a ruthenium complex dye adsorbed. Numeral 5 denotes an electrolytic solution, for which an iodine electrolyte containing iodine dissolved in a potassium iodide aqueous solution is generally used.

Numeral 4 denotes a sealing material, and 7 denotes a load, such as a resistor.

The use efficiency of the sunlight of the dye sensitized solar cell is theoretically 30% and is practically 10% at maximum.

While titanium dioxide has a photocatalyst function, the use of fused quartz particles treated with halogen acid as a material having the similar photocatalyst function is shown in JP-A-2004-290748 and JP-A-2004-290747.

Similarly, the use of synthetic quartz particles treated with halogen acid as a material having a photocatalyst function is shown in WO 2005/089941.

The synthetic quartz photocatalyst functions as a photocatalyst within a wavelength range of from 200 to 800 nm, which is further wider than that of the photocatalyst formed from fused quartz as a raw material shown in JP-A-2004-290748 and. JP-A-2004-290747.

Furthermore, the present inventors have found that silicon dioxide represented by synthetic quartz may be used as a solar cell, and the solar cell is described in WO 2011/049156.

The silicon dioxide is colorless.

Silicon dioxide functions as a solar cell material by being treated with halogen acid even when it is not synthetic quartz, which is a crystalline material, but glass particles, which is an amorphous material, such as quartz glass, non-alkali glass, borosilicate glass and soda-lime glass.

An example of the structure of the silicon dioxide solar cell shown in WO 2011/049156 is described with reference to FIG. 3.

In FIG. 3, numerals 1 and 3 denote glass substrates each forming on one surface thereof an FTO transparent conductive layer 2, and light enters on the side of the glass substrate 1. Numeral 9 denotes particles formed by pulverizing a silicon dioxide sintered material. An electrolytic solution coexists with the silicon dioxide particles 9, for which an iodine electrolyte containing iodine dissolved in a potassium iodide aqueous solution is generally used.

An n-type semiconductor layer 10, such as zinc oxide (ZnO) and titanium dioxide (TiO₂), is formed on the FTO layer 2 on the glass substrate 1 that is on the light incident side.

A platinum film 8 is formed on the FTO layer 2 of the glass substrate 3 that is not on the light incident side.

A solar cell material 9 formed by mixing glass containing SiO₂ and an organic electrolyte is filled to a thickness of from 0.15 to 0.20 mm between the n-type semiconductor layer 10 and the platinum film 8.

The solar cell material 9 used is obtained in such a manner that particles of glass containing SiO₂ and the like are immersed in a 5% hydrofluoric acid aqueous solution for 5 minutes, rinsed with water and then dried, and pulverized to a particle diameter of 0.2 mm or less.

The iodine electrolyte is obtained by adding 0.1 mol of LiI, 0.05 mol of I₂, 0.5 mol of 4-tert-butylpyridine and 0.5 mol of tetrabutylammonium iodide to an acetonitrile solvent.

Numeral 4 denotes a sealing material, and 7 denotes a load, such as a resistor.

### PRIOR ART REFERENCES

Document 1: JP-A-2004-290748

Document 2: JP-A-2004-290747

Document 3: WO 2005/089941

Document 4: WO 2011/049156

### DISCLOSURE OF THE INVENTION

### Object of The Invention

The invention relating to the application is to provide a solar cell that exhibits excellent performance by combining a titanium dioxide solar cell and a silicon dioxide solar cell.

### Means

In the invention relating to the application, a titanium dioxide solar cell and a silicon dioxide solar cell are combined to form a tandem structure, or a titanium dioxide solar cell and a silicon dioxide solar cell are combined to form a tandem structure in a single container, and output power is taken from an electrode on the side of the titanium dioxide solar cell and an electrode on the side of the silicon dioxide solar cell.

In addition, a ruthenium complex dye, which is used as a sensitizing dye for a titanium dioxide solar cell, is adsorbed on silicon dioxide.

A metal plate may be used instead of the glass plate facing the glass plate on the light incident side.

The invention relating to the application further includes the following features.

(1) A tandem solar cell constituted by two glass substrates each having a transparent conductive layer formed thereon that are disposed to allow the transparent conductive layers to face each other, a titanium dioxide layer that is disposed on one of the glass substrates, a silicon dioxide layer that is disposed on the other thereof, and an electrolyte that is filled between the two glass substrates.

(2) The tandem solar cell of the item (1) constituted in such a manner that a sensitizing dye is adsorbed on the titanium dioxide layer.

(3) The tandem solar cell of the item (1) constituted in such a manner that a sensitizing dye is adsorbed on the silicon dioxide layer.

(4) A tandem solar cell constituted by a glass substrate having a transparent conductive layer formed thereon and a metal plate that are disposed to allow the transparent conductive layer to face the metal plate, a titanium dioxide layer that is disposed on the glass substrate, a silicon dioxide layer that is disposed on the metal plate, and an electrolyte that is filled between the glass substrate and the metal plate.

(5) The tandem solar cell of the item (4) constituted in such a manner that a sensitizing dye is adsorbed on the titanium dioxide layer.

(6) The tandem solar cell of the item (4) constituted in such a manner that a sensitizing dye is adsorbed on the silicon dioxide layer.

(7) A tandem solar cell constituted by a glass substrate having a transparent conductive layer formed thereon and a metal plate that are disposed to allow the transparent conductive layer to face the metal plate, a silicon dioxide layer that is disposed on the glass substrate, a titanium dioxide layer that is disposed on the metal plate, and an electrolyte that is filled between the glass substrate and the metal plate.

(8) The tandem solar cell of the item (7) constituted in such a manner that a sensitizing dye is adsorbed on the titanium dioxide layer.

(9) The tandem solar cell of the item (7) constituted in such a manner that a sensitizing dye is adsorbed on the silicon dioxide layer.

### Effects

A silicon dioxide solar cell generates electric power with visible light to infrared light. Accordingly, by combining a silicon dioxide solar cell generating electric power with other light than ultraviolet light, which is not utilized for electric generation of a titanium dioxide solar cell generating electric power with ultraviolet light, the use efficiency of light, particularly the sunlight, is largely enhanced.

### BRIEF DESCRIPTION OF DRAWINGS

FIG. 1 shows a schematic illustration of a structure of a conventional titanium dioxide solar cell.

FIG. 2 shows a schematic illustration of a structure of a conventional dye sensitized titanium dioxide solar cell.

FIG. 3 shows a schematic illustration of a structure of a conventional silicon dioxide solar cell of the related art.

FIG. 4 shows a schematic illustration of a structure of a silicon dioxide solar cell of the related art.

FIG. 5 shows a schematic illustration of a structure of a solar cell of Embodiment 1.

FIG. 6 shows a schematic illustration of a structure of a solar cell of Embodiment 2.

FIG. 7 shows a schematic illustration of a structure of a solar cell of Embodiment 3.

FIG. 8 shows a schematic illustration of a structure of a solar cell of Embodiment 4.

FIG. 9 shows a schematic illustration of a structure of a solar cell of Embodiment 5.

FIG. 10 shows a schematic illustration of a structure of a solar cell of Embodiment 6.

FIG. 11 shows a schematic illustration of a structure of a solar cell of Embodiment 7.

FIG. 12 shows a schematic illustration of a structure of a solar cell of Embodiment 8.

### DESCRIPTION OF EMBODIMENTS

Embodiments are described below with reference to the drawings.

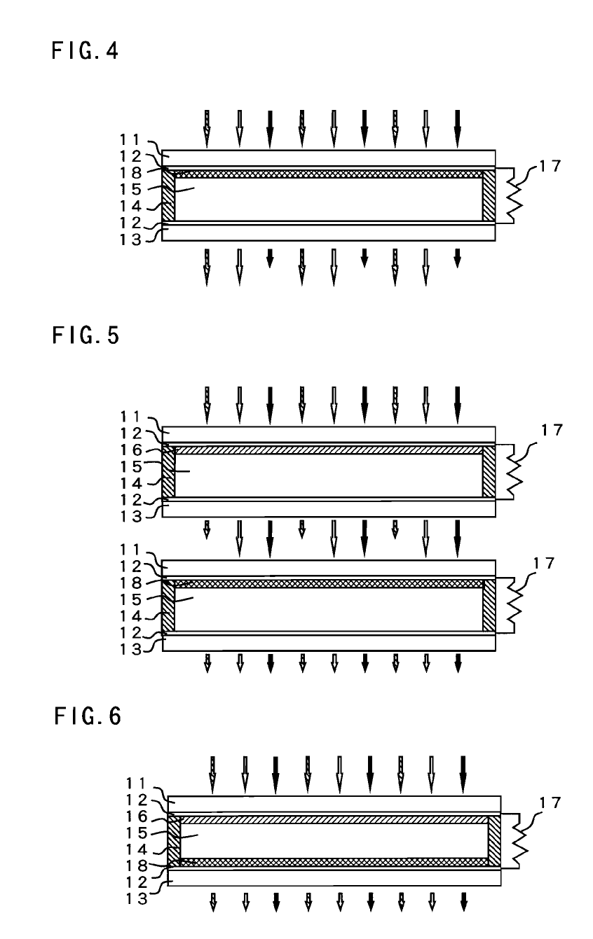

The silicon dioxide solar cell that has been shown in another application by the present inventors is described with reference to FIG. 4.

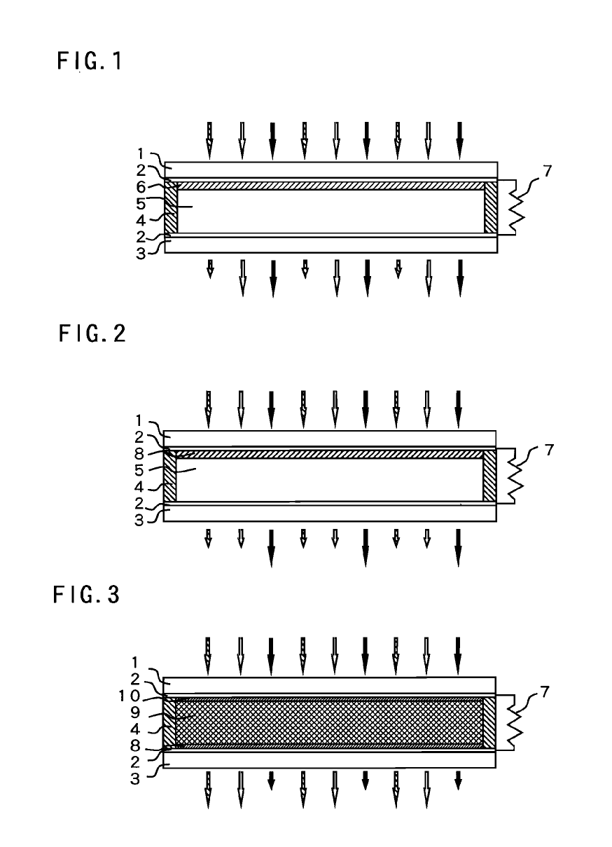

The solar cell is obtained by constituting the silicon dioxide solar cell shown in FIG. 3 based on the structure of titanium dioxide solar cell shown in FIG. 1.

In FIG. 4, numeral 11 denotes a glass substrate formed of a general-purpose glass plate, forming on one surface thereof a transparent conductive layer 12, such as FTO, being a light incident side surface. Numeral 13 denotes a glass substrate formed of a general-purpose glass plate, as similar to 11, forming on one surface thereof a transparent conductive layer 12, such as FTO, being a light outgoing side surface. The glass substrate 11 and the glass substrate 13 are disposed to allow the transparent conductive layers 12 thereof to face each other.

A silicon dioxide particle sintered material is disposed on the transparent conductive layer 12 of the glass substrate 11 on the light incident side.

The silicon dioxide particles are synthetic quartz particles formed by pulverizing crystalline synthetic quartz particles or amorphous glass particles to a particle diameter of 0.2 mm or less, and desirably 500 nm or less, having been treated with halogen acid, and the silicon dioxide particle sintered material is formed by mixing with ethanol and coating and drying on the transparent conductive layer 12 having a layer of platinum or the like formed thereon.

As the silicon dioxide particles, a rock crystal which is a crystalline material of silicon dioxide or glass particles such as quartz glass, non-alkali glass, borosilicate glass and soda-lime glass which are amorphous materials of silicon dioxide may be used, and coarsely pulverized silicon dioxide particles are immersed in hydrofluoric acid aqueous solution, and then the rock crystal particles or glass particles are rinsed with water and then dried, followed by pulverizing finely. In addition to hydrofluoric acid, hydrochloric acid or hydrobromic acid may be used as the halogen acid, and hydrofluoric acid is preferred.

The diameter of the silicon dioxide particles is not limited to fine particles of 500 nm or less, and those having a diameter of approximately 0.2 mm may be used.

As the electrode on the light incident side, CuO, MgO, ZnO, SrTiO₃, carbon nitride, graphene and the like may be used in addition to titanium dioxide.

An electrolyte 15 is filled between the two glass substrates 11 and 13.

Numeral 14 denotes a sealing material, and 17 denotes an external load.

The electrolyte 15 used may be most simply an iodine electrolyte containing iodine dissolved in a potassium iodide aqueous solution, but the electrolyte is colored, and the electrolyte shown below may be used in the case where it is necessarily colorless.

1-Ethyl-3-methylimidazolium iodide: 0.4 M,

tetrabutylammonium iodide: 0.4 M,

4-t-butylpyridine: 0.2 M and

guanidium isothiocyanate: 0.1 M

are prepared as a propylene carbonate liquid.

The electrolytic solution is substantially colorless and transparent to the visible light region in the case where the concentration of halogen molecules, such as I₂ and Br₂, is 0.0004 mol/L or less.

In addition, the following electrolyte may be used.

0.5 mol of lithium iodide (LiI) and 0.05 mol of metallic iodine (I₂) are prepared with polyethylene glycol having a molecular weight of 220 as a solvent.

The following electrolyte may also be used.

0.5 mol of lithium iodide (LiI) and 0.05 mol of metallic iodine (I₂) are dissolved in methoxypropionitrile, to which a thickening agent is added, and 4-tert-butylpyridine is further added for enhancing the open circuit voltage and the fill factor.

Examples of an electrolyte that provides the maximum value include the following.

LiI and I₂, 3-methoxypropionitrile as a solvent, 1-propyl-2, 3-dimethylimidazolium iodide as an ambient temperature molten salt for reducing the viscosity and facilitating diffusion of ions, and 4-tert-butylpyridine for preventing the reverse current and enhancing the open circuit voltage are mixed at prescribed ratios.

In the case where there is no demand of colorless transparency, a colored electrolytic solution, such as an iodine electrolytic solution with a reduced concentration, may be used.

Examples of the colorless electrolyte used include acetic acid and citric acid.

Output wires were attached to between the FTO layers 2 and 2 as output electrodes of this solar cell, the light incident side glass substrate 1 was irradiated with light having illuminance of from 15,000 to 19,000 lux with a fluorescent light as an irradiation light source, and the open circuit voltage and the short-circuit current between the output electrodes were measured.

As the solar cell material, synthetic quartz, fused quartz glass, soda-lime glass, non-alkali glass and borosilicate glass were tested. The results are as follows.

(1) A solar cell using synthetic quartz exhibited an open circuit voltage of 35 mV and a short-circuit current of 0.5 μA.

(2) A solar cell using fused quartz glass exhibited an open circuit voltage of 30 mV and a short-circuit current of 0.5 μA.

(3) A solar cell using soda-lime glass exhibited an open circuit voltage of 15 mV and a short-circuit current of 0.3 μA.

(4) A solar cell using non-alkali glass exhibited an open circuit voltage of 30 mV and a short-circuit current of 0.4 μA.

(5) A solar cell using borosilicate glass exhibited an open circuit voltage of 14 mV and a short-circuit current of 0.3 μA.

A silicon dioxide composition that was not treated with hydrofluoric acid provided the open circuit voltage and the short-circuit current shown below.

(1) A solar cell using synthetic quartz exhibited an open circuit voltage of 3 mV and a short-circuit current of 0.1 μA.

(2) A solar cell using fused quartz glass exhibited an open circuit voltage of 3 mV and a short-circuit current of 0.2 μA.

(3) A solar cell using soda-lime glass exhibited an open circuit voltage of 5 mV and a short-circuit current of 0.1 μA.

(4) A solar cell using non-alkali glass exhibited an open circuit voltage of 5 mV and a short-circuit current of 0.1 μA.

(5) A solar cell using borosilicate glass exhibited an open circuit voltage of 12 mV and a short-circuit current of 0.2 μA.

It is comprehended from the above results that silicon dioxide has a function of a photovoltaic cell, and the photoelectromotive force is considerably increased by treating with hydrofluoric acid.

In the case where the halogen acid used for the treatment was hydrochloric acid, and similarly the organic electrolyte containing 0.1 mol of LiI, 0.05 mol of I₂, 0.5 mol of 4-tert-butylpyridine and 0.5 mol of tetrabutylammonium iodide added to an acetonitrile solvent was used, the resulting open circuit voltage was 4 mV, and the resulting short-circuit current was 0.1 μA.

When the short-circuit current was measured under the illuminance that was approximately equivalent to the direct sunlight with a 300 W incandescent light bulb containing no ultraviolet component, it was observed that the open circuit voltage was 400 mV, and the short-circuit current was 0.5 μA.

It is understood from the above that the synthetic quartz solar cell generates electric power with light containing no ultraviolet component.

The titanium dioxide solar cell shown in FIG. 1 generates electric power only with ultraviolet light having the wavelength of 380 nm or less, which constitutes only 4% of the sunlight, and thus the use efficiency of the sunlight is 4% at maximum and is practically 1% at most.

In the case of a dye sensitized solar cell, in which for addressing the defect of the titanium dioxide solar cell having a narrow usable wavelength range, the usable light range is expanded to the visible light region having the longer wavelength than ultraviolet light by adsorbing a ruthenium complex dye to sintered porous titanium dioxide, light that contributes to electric generation is only a part of the visible light, and the use efficiency of the sunlight is theoretically 30% and is practically 10% at maximum.

As described above, when the short-circuit current was measured under the illuminance that is approximately equivalent to the direct sunlight with a 300 W incandescent light bulb containing no ultraviolet component, it was observed that the open circuit voltage was 400 mV, and the short-circuit current was 0.5 μA.

For investigating the influence on infrared ray transmission of the silicon dioxide solar cell, the silicon dioxide solar cell and the FTO glass constituting the two sheets on both sides of the solar cell were measured for light transmittance, and the results are shown in Table 1.

In Table 1, the numerals on the upper lines show the transmittance, and the numerals in parentheses on the lower lines show the shielding ratio.

TABLE 1

| | 289 nm | 470 nm | 800 nm |
|---|---|---|---|
| FTO | 0% | 65% | 84.3% |
| | 100% | (35%) | (15.7%) |
| Cell | 0% | 0% | 15.3% |
| | (100%) | (100%) | (84.7%) |

As shown in the above table, the silicon dioxide solar cell shields substantially completely light in the wavelength range of 470 nm or less, and the FTO glass shields substantially completely light in the wavelength range of 289 nm or less but transmits 65% or more of light in the wavelength range of from 289 to 470 nm.

The silicon dioxide solar cell shields 84.7% of light having the wavelength of 800 nm, but the shielding ratio of the FTO glass therefor is only 15.7%.

In consideration of both the shielding of infrared light and the electric generation with an incandescent light bulb, it is considered that the silicon dioxide solar cell generates electric power with the incident infrared light too.

In the embodiments described below, a titanium dioxide solar cell generating electric power with ultraviolet light or a dye sensitized titanium dioxide solar cell generating electric power with ultraviolet light and visible light and a silicon dioxide solar cell generating electric power with visible light and infrared light are combined, thereby generating electric power with light of the entire wavelength range of the incident light from the sunlight or the like.

### EMBODIMENT 1

Embodiment 1 shown in FIG. 5 is a solar cell having a fundamental tandem structure containing a titanium dioxide solar cell and a silicon dioxide solar cell combined.

The solar cell having the tandem structure is constituted by disposing in series the conventional titanium dioxide solar cell shown in FIG. 1 and the silicon dioxide solar cell of the related art shown in FIG. 4.

What is disposed on the upper side is the titanium dioxide solar cell, and in the solar cell, numerals 11 and 13 denote glass substrates each forming on one surface thereof an FTO transparent conductive layer 12, and light enters on the side of the glass substrate 11. Numeral 16 denotes a porous titanium dioxide sintered material. Numeral 15 denotes an electrolytic solution, for which an iodine electrolyte containing iodine dissolved in a potassium iodide aqueous solution is generally used.

Numeral 14 denotes a sealing material, and 17 denotes a load, such as a resistor.

What is disposed on the lower side is the silicon dioxide solar cell, and in the solar cell, numerals 11 and 13 denote glass substrates each forming on one surface thereof an FTO transparent conductive layer 12, and light enters on the side of the glass substrate 11. Numeral 18 denotes a silicon dioxide sintered material. Numeral 15 denotes an electrolytic solution, for which an iodine electrolyte containing iodine dissolved in a potassium iodide aqueous solution is generally used.

Numeral 14 denotes a sealing material, and 17 denotes a load, such as a resistor.

The sunlight including ultraviolet light, visible light and infrared light enters on the side of the glass substrate 11 of the titanium dioxide solar cell of the solar cell having a tandem structure.

In the titanium dioxide solar cell, titanium dioxide generates electric power with ultraviolet light, and ultraviolet light is outgoing after attenuation, but visible light and infrared light are directly outgoing other than having been absorbed.

After outgoing, the attenuated ultraviolet light, and visible light and infrared light enters on the side of the glass substrate 11 of the silicon dioxide solar cell.

In the silicon dioxide solar cell, silicon dioxide generates electric power with visible light and infrared light, and visible light and infrared light are also outgoing after attenuation.

Ultraviolet light, which allows the composite glass plate using titanium dioxide electric generation, is hard to pass through the solar cell as compared to visible light and infrared light, which allow silicon dioxide electric generation, and therefore, the titanium dioxide solar cell is disposed preferably on the side where light enters.

It is obvious that the silicon dioxide solar cell may be disposed on the side where light enters.

It is obvious that a sensitizing dye may be added to the titanium dioxide sintered material, which is similarly applied to the examples described hereinbelow.

### EMBODIMENT 2

The tandem solar cell of Embodiment 2 is described with reference to FIG. 6. The tandem solar cell of Embodiment 2 contains a solar cell using titanium dioxide and a solar cell using silicon dioxide, which are housed in one container with an electrolyte as the common constitutional element. Ultraviolet light, which allows titanium dioxide electric generation, is hard to pass through the solar cell as compared to visible light and infrared light, which are shielded by silicon dioxide and allow silicon dioxide electric generation, and therefore, the titanium dioxide layer is disposed on the glass substrate on the side where light enters.

In FIG. 6, numeral 11 denotes a glass substrate formed of a glass plate, forming on one surface thereof a transparent conductive layer 12, such as FTO, to provide a light incident surface. Numeral 13 denotes a glass substrate formed of a general-purpose glass plate, as similar to 11, forming on one surface thereof a transparent conductive layer 12, such as FTO, to provide a light outgoing surface. The glass substrate 11 and the glass substrate 13 are disposed to allow the transparent conductive layers 12 thereof to face each other.

A titanium dioxide layer 16 is disposed on the transparent conductive layer 12 of the glass substrate 11 on the light incident side, and a silicon dioxide layer 18 is disposed on the transparent conductive layer 12 on the glass substrate 13 on the light outgoing side.

It is obvious that the silicon dioxide layer 18 may be disposed on the side of the light incident surface, and the titanium dioxide layer may be disposed on the side of the light outgoing surface.

An electrolyte 15 is filled between the two glass substrates 11 and 13.

Numeral 14 denotes a sealing material, and 17 denotes an external load, which is connected to the transparent conductive layers 12 and 12.

The titanium dioxide layer 16 may be a titanium dioxide film that is formed by such a measure as sputtering, chemical vapor deposition (CVD), physical vapor deposition (PVD), a sol-gel method, a plating method, an electrolytic polymerization method and a molecular precursor method in some cases, or may be a titanium dioxide porous sintered material that is solidified by such a measure as sintering in other cases.

In the case using the molecular precursor method, titanium dioxide particles are preferably added separately for enhancing the capability.

On the light incident side, CuO, MgO, ZnO, SrTiO₃, carbon nitride, graphene and the like may be used in addition to titanium dioxide.

The particles of the silicon dioxide sintered material 50 are synthetic quartz particles pulverized to a particle diameter of 0.2 mm or less, and desirably 500 nm or less, and is mixed with ethanol and coated and dried on the transparent conductive layer 12 having a layer of platinum or the like formed thereon.

As the silicon dioxide particles, a synthetic quartz which is a crystalline material of silicon dioxide or glass particles such as quartz glass, non-alkali glass, borosilicate glass and soda-lime glass which are amorphous materials of silicon dioxide may be used, and coarsely pulverized silicon dioxide particles are immersed in a hydrofluoric acid aqueous solution, and then the synthetic quartz particles or glass particles are rinsed with water and then dried, followed by pulverizing finely. In addition to hydrofluoric acid, hydrochloric acid may be used as the halogen acid, and hydrofluoric acid is preferred.

The synthetic quartz particles or the other glass particles may be treated with halogen acid other than hydrofluoric acid, such as hydrochloric acid or hydrobromic acid.

The electrolyte 15 used may be most simply an iodine electrolyte containing iodine dissolved in a potassium iodide aqueous solution, and other electrolytes may be used.

As similar to the solar cell of Embodiment 1, an electrolyte having the following composition is useful.

1-Ethyl-3-methylimidazolium iodide: 0.4 M,

tetrabutylammonium iodide: 0.4 M,

4-t-butylpyridine: 0.2 M and

guanidinium isothiocyanate: 0.1 M

are prepared as a propylene carbonate solution.

The electrolytic solution is substantially colorless and transparent to the visible light region in the case where the concentration of halogen molecules, such as I₂ and Br₂, is 0.0004 mol/L or less.

Furthermore, acetic acid, citric acid and the like, which are colorless and transparent, may be used as the colorless transparent electrolyte.

The tandem-solar cell was measured for characteristics as a solar cell by irradiating the solar cell having an area of 1 cm×1 cm with light of 1 kw/m which was the solar constant, with a solar simulator, and a short-circuit current of 348 μA and an open circuit voltage of 620 mV were obtained.

When the area of the tandem solar cell was changed to 2 cm×2 cm, a short-circuit current of 1.7990 mA and an open circuit voltage of 570 mV were obtained, and thus a solar cell with a larger area exhibited a larger photo-generation efficiency, which was contrary to an ordinary solar cell.

In the case of the synthetic quartz particles having a particle diameter of 0.2 mm or less, a short-circuit current of 20 μA and an open circuit voltage of 417 mV were obtained with an area of 1 cm×1 cm.

There was no significant difference found between the case where the side of the silicon dioxide was irradiated and the case where the side of the titanium dioxide was irradiated.

While titanium dioxide is used on the light incident side in the embodiment, other suitable materials, such as zinc oxide, may be selected.

### EMBODIMENT 3

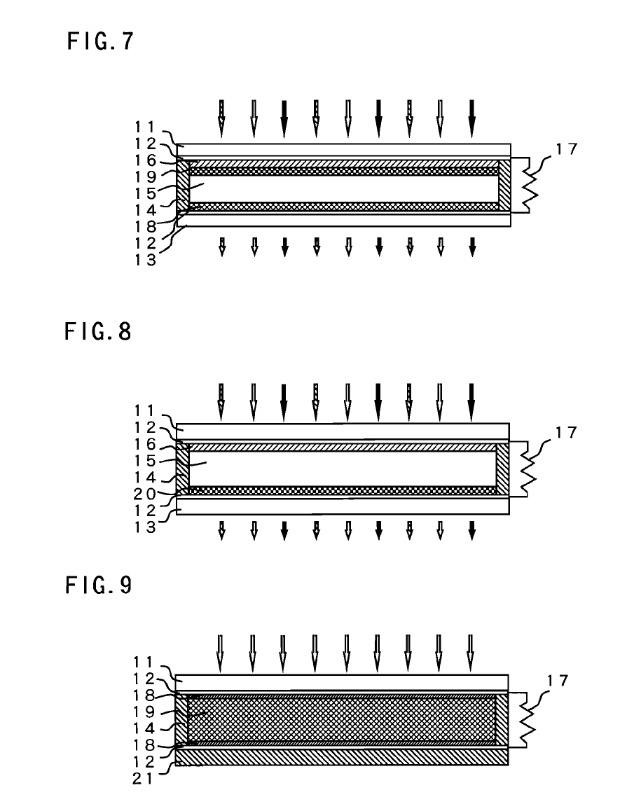

The tandem solar cell of Embodiment 3 shown in FIG. 7 is a tandem solar cell that contains titanium dioxide particles 19 used in addition to the titanium dioxide layer 16 of the tandem solar cell of Embodiment 2.

The titanium dioxide particles are dispersed over the titanium dioxide film 16 and then fixed by such a measure as sintering the whole.

There is no difference in other structures and modified structures from the tandem solar cell of Embodiment 2, and a further description is omitted.

### EMBODIMENT 4

The tandem solar cell of Embodiment 3 shown in FIG. 8 is a tandem solar cell that contains a sensitizing dye, such as a ruthenium complex, adsorbed on the silicon dioxide layer 14 of the tandem solar cell of Embodiment 2.

There is no difference in other structures and modified structures from the tandem solar cell of Embodiment 2, and a further description is omitted.

The silicon dioxide photoelectromotive element 9 is formed in such a manner that a ruthenium sensitizing dye is adsorbed on synthetic quartz fine particles having a particle diameter of 500 nm or less having been treated with hydrofluoric acid, and the particles are mixed with platinum powder with ethanol as a solvent and coated on the FTO film 2, followed by sintering.

In the tandem solar cell of Embodiment 4 having the silicon dioxide photoelectromotive element having a sensitizing dye adsorbed thereon and the sintered porous titanium dioxide electromotive element, which are disposed in series with respect to the incident light, the silicon dioxide electromotive element generates electric power with light having the longer wavelength than that of visible light, while ultraviolet light is transmitted. The sensitizing dye generates electric power with light in the visible light region, and the sintered porous titanium dioxide electromotive element generates electric power with ultraviolet light having been passed through the silicon dioxide photoelectromotive element. Accordingly, the tandem solar cell of Embodiment 2 generates electric power by utilizing effectively light with a wide wavelength range.

The sintered material of silicon dioxide powder and platinum powder is less colored as compared to titanium dioxide since the adsorbed amount of the ruthenium complex sensitizing dye is not large.

Accordingly, there is less overall coloration when a colorless and transparent electrolyte is used.

### EMBODIMENT 5

In the case where the solar cell is not used as a window glass but is provided on the roof or the like, the counter electrode may not be transparent, and a metal plate may be used as the counter electrode, thereby enhancing the strength of the solar cell and simplifying the structure thereof.

What is shown in FIG. 9 is a solar cell, in which the counter electrode of the conventional solar cell shown in FIG. 3 is replaced by a metal plate.

The difference between the solar cell of Embodiment 5 and the conventional solar cell is only that the counter electrode is changed from the FTO glass 2 and the glass substrate 3 to a metal plate 21, and a further description is omitted.

As the metal plate 21, aluminum, silver, nickel and the like may be used, and an alloy or a composite material may be used in the case where the corrosion resistance to the electrolyte is considered.

### EMBODIMENT 6

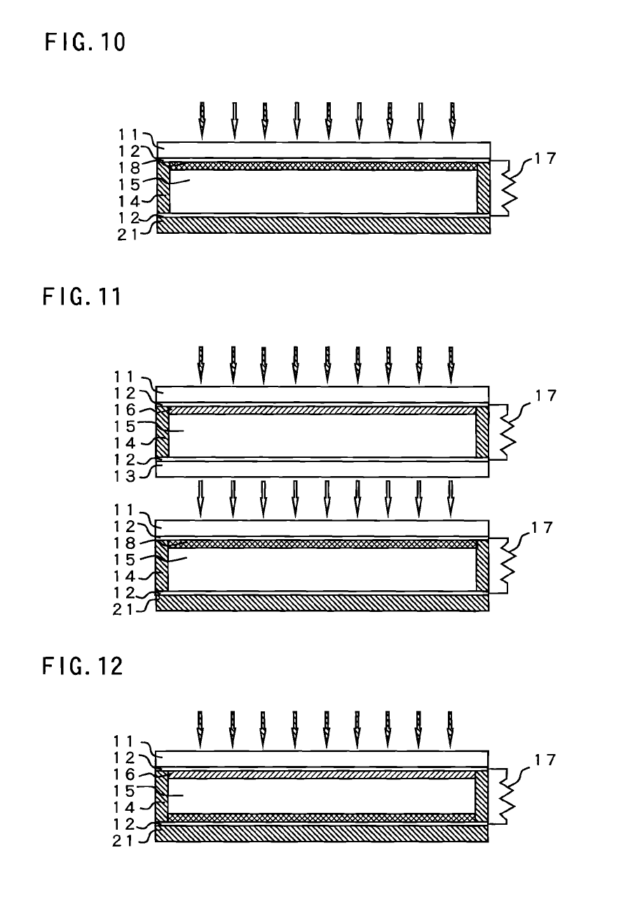

The solar cell of Embodiment 6 shown in FIG. 10 has only the difference that the Fro glass 2 and the glass substrate 3 of the silicon dioxide solar cell of the related art shown in FIG. 4 are changed to a metal plate 21, and a further description is omitted.

### EMBODIMENT 7

The solar cell of Embodiment 7 shown in FIG. 11 has only the difference that the FTO film 12 and the glass substrate 13 of the silicon dioxide solar cell of the tandem solar cell of Embodiment 1 shown in FIG. 5 are changed to a metal plate 21, and a further description is omitted.

EMBODIMENT 8

The solar cell of Embodiment 8 shown in FIG. 12 has only the difference that the FTO film 12 and the glass substrate 13 of the tandem solar cell of Embodiment 2 shown in FIG. 6 are changed to a metal plate 21, and a further description is omitted.

### INDUSTRIAL APPLICABILITY

The tandem solar cell containing a solar cell using silicon dioxide and a titanium dioxide solar cell combined generates electric power with a wide range of light including from ultraviolet light to infrared light, and thus is useful for solving the energy problem.

### REFERENCE SIGNS LIST

1, 3, 11, 13 glass substrate

2, 12 FTO transparent conductive layer

4, 14 sealing material

5, 15 electrolytic solution

6 titanium dioxide film

8 sensitizing dye-added titanium dioxide porous sintered material

18 silicon dioxide sintered material

21 metal plate

1. A tandem solar cell comprising two glass substrates each having a transparent conductive layer formed thereon that are disposed to allow the transparent conductive layers to face each other;
a titanium dioxide photoelectromotive element that is disposed on one of aid glass substrates; a silicon dioxide photoelectromotive element that is disposed on the other of said glass substrates; and
an electrolyte that is filled between the two glass substrates.

2. The tandem solar cell according to claim 1, wherein a sensitizing dye is adsorbed on said titanium dioxide photoelectromotive element.

3. The tandem solar cell according to claim 1, wherein a sensitizing dye is adsorbed on said silicon dioxide photoelectromotive element.

4. A tandem solar cell comprising
a glass substrate having a transparent conductive layer formed thereon and a metal plate that are disposed to allow the transparent conductive layer to face the metal plate;
a titanium dioxide photoelectromotive element that is disposed on said glass substrate;
a silicon dioxide photoelectromotive element that is disposed on said metal plate; and
an electrolyte that is filled between said glass substrate and said metal plate.

5. The tandem solar cell according to claim 4, wherein a sensitizing dye is adsorbed on said titanium dioxide photoelectromotive element.

6. The tandem solar cell according to claim 4, wherein a sensitizing dye is adsorbed on said silicon dioxide photoelectromotive element.

7. A tandem solar cell comprising
a glass substrate having a transparent conductive layer formed thereon and a metal plate that are disposed to allow said transparent conductive layer to face said metal plate;
a silicon dioxide photoelectromotive element that is disposed on said glass substrate;
a titanium dioxide photoelectromotive element that is disposed on said metal plate; and
an electrolyte that is filled between said glass substrate and said metal plate.

8. The tandem solar cell according to claim 7, wherein a sensitizing dye is adsorbed on said titanium dioxide photoelectromotive element.

9. The tandem solar cell according to claim 7, wherein a sensitizing dye is adsorbed on said silicon dioxide photoelectromotive element.
